(19) United States
(12) Patent Application Publication
(10) Pub. No.: US 2025/0106717 A1
(43) Pub. Date: Mar. 27, 2025

(54) METHOD AND APPARATUS FOR MOBILITY MANAGEMENT IN COMMUNICATION SYSTEM

(71) Applicant: ELECTRONICS AND TELECOMMUNICATIONS RESEARCH INSTITUTE, Daejeon (KR)

(72) Inventors: Hyung Deug BAE, Daejeon (KR); Sook Yang KANG, Daejeon (KR); Chul PARK, Daejeon (KR); Myungsan BAE, Daejeon (KR); Jaesheung SHIN, Daejeon (KR); Jae Wook SHIN, Daejeon (KR); Sung-Min OH, Daejeon (KR); Kwang Ryul JUNG, Daejeon (KR); You Sun HWANG, Daejeon (KR)

(21) Appl. No.: 18/891,425

(22) Filed: Sep. 20, 2024

(30) Foreign Application Priority Data
Sep. 22, 2023 (KR) 10-2023-0127302
Sep. 10, 2024 (KR) 10-2024-0123488

(51) Int. Cl. H04W 36/08; H04W 36/00

(52) U.S. Cl. CPC H04W 36/083; H04W 36/00835; H04W 36/0085

(57) ABSTRACT

A method of a terminal may comprise: receiving system information including terrestrial cell reselection parameters and on-board cell reselection parameters; determining whether the terminal is in an on-board state with respect to a first base station; and in response to determining that the terminal is in the on-board state with respect to the first base station, performing cell reselection by applying the on-board cell reselection parameters to reception measurement on the first base station.

### CROSS-REFERENCE TO RELATED APPLICATIONS

This application claims priority to Korean Patent Applications No. 10-2023-0127302, filed on Sep. 22, 2023, and No. 10-2024-0123488, filed on Sep. 10, 2024, with the Korean Intellectual Property Office (KIPO), the entire contents of which are hereby incorporated by reference.

### BACKGROUND

### 1. Technical Field

The present disclosure relates to a mobility management technique in a communication system, and more particularly, to a mobility management technique in a communication system, which enable management of terminal mobility according to movement of a moving base station.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

The communication systems may include terrestrial base stations, moving base stations, and terminals. The terrestrial base stations may be fixed base stations. The moving base stations may be mounted on land and sea transportation vehicles such as buses, trains, and ships, or on aerial vehicles like urban air mobility (UAM). Some of the terminals may be located in the transportation vehicles. These specific terminals may be referred to as on-board terminals. In an environment where coverages of a fixed (terrestrial) base station and a moving base station overlap, an on-board terminal may be connected to either the terrestrial base station or the moving base station. In this case, it may be preferable for the on-board terminal to connect to the moving base station mounted on the vehicle in which a passenger carrying the on-board terminal is traveling. If the on-board terminal is camped on a terrestrial cell, frequent cell reselection may occur as the moving base station moves.

### SUMMARY

The present disclosure for resolving the above-described problems is directed to providing a method and an apparatus for mobility management in a communication system, which enable management of terminal mobility according to movement of a moving base station.

A mobility management method in a communication system, according to a first exemplary embodiment of the present disclosure, as a method of a terminal, may comprise: receiving system information including terrestrial cell reselection parameters and on-board cell reselection parameters; determining whether the terminal is in an on-board state with respect to a first base station; and in response to determining that the terminal is in the on-board state with respect to the first base station, performing cell reselection by applying the on-board cell reselection parameters for cell reselection evaluation on the first base station.

The method may further comprise: before determining whether the terminal is in the on-board state with respect to the first base station, camping on the first base station, wherein the first base station may be a moving base station.

The method may further comprise: before determining whether the terminal is in the on-board state with respect to the first base station, camping on a second base station, wherein the first base station may be a moving base station and the second base station may be a terrestrial base station.

The method may further comprise: in response to determining that the terminal is not in the on-board state with respect to the first base station, performing cell reselection by applying the terrestrial cell reselection parameters for cell reselection evaluation on the first base station.

The determining of whether the terminal is in the on-board state with respect to the first base station may comprise: receiving a signal from the first base station; measuring a received signal strength of the signal received from the first base station; and performing primary determination on whether the terminal is in the on-board state with respect to the first base station based on a variation in the measured received signal strength.

The performing of the primary determination on whether the terminal is in the on-board state with respect to the first base station may comprise: calculating the variation in the measured received signal strength during an on-board evaluation period; and determining whether the terminal is in the on-board state with respect to the first base station by comparing the variation in the received signal strength with a threshold value.

The determining of whether the terminal is in the on-board state with respect to the first base station by comparing the variation in the received signal strength with the threshold value may comprise: determining whether the variation in the received signal strength exceeds the threshold value, wherein the terminal may be determined to be in the on-board state with respect to the first base station when the variation in the received signal strength does not exceed the threshold value, and the terminal may be determined to be not in the on-board state with respect to the first base station when the variation in the received signal strength exceeds the threshold value.

The determining of whether the terminal is in the on-board state with respect to the first base station may comprise: in response to determining that the terminal is in the on-board state with respect to the first base station according to a result of the primary determination, performing a secondary determination on whether mobile integrated access and backhaul (IAB) indication information exists in the system information; and in response to determining that the mobile IAB indication information exists in the system information, determining that the terminal is in the on-board state with respect to the first base station as a result of the secondary determination.

A cell reselection priority of the on-board cell reselection parameters may be higher than a cell reselection priority of the terrestrial cell reselection parameters.

A Q-offset of the on-board cell reselection parameters may be smaller than a Q-offset of the terrestrial cell reselection parameters.

A Q-hysteresis of the on-board cell reselection parameters may be bigger than a Q-hysteresis of the terrestrial cell reselection parameters.

A mobility management apparatus in a communication system, according to a second exemplary embodiment of the present disclosure, as a terminal, may comprise: at least one processor, and the at least one processor may cause the terminal to perform: receiving system information including terrestrial cell reselection parameters and on-board cell reselection parameters; determining whether the terminal is in an on-board state with respect to a first base station; and in response to determining that the terminal is in the on-board state with respect to the first base station, performing cell reselection by applying the on-board cell reselection parameters for cell reselection evaluation on the first base station.

The at least one processor may cause the terminal to perform: before determining whether the terminal is in the on-board state with respect to the first base station, camping on the first base station, wherein the first base station may be a moving base station.

The at least one processor may cause the terminal to perform: before determining whether the terminal is in the on-board state with respect to the first base station, camping on a second base station, wherein the first base station may be a moving base station and the second base station may be a terrestrial base station.

The at least one processor may cause the terminal to perform: in response to determining that the terminal is not in the on-board state with respect to the first base station, performing cell reselection by applying the terrestrial cell reselection parameters for cell reselection evaluation on the first base station.

In the determining of whether the terminal is in the on-board state with respect to the first base station, the at least one processor may cause the terminal to perform: receiving a signal from the first base station; measuring a received signal strength of the signal received from the first base station; and performing primary determination on whether the terminal is in the on-board state with respect to the first base station based on a variation in the measured received signal strength.

In the performing of the primary determination on whether the terminal is in the on-board state with respect to the first base station, the at least one processor may cause the terminal to perform: calculating the variation in the measured received signal strength during an on-board evaluation period; and determining whether the terminal is in the on-board state with respect to the first base station by comparing the variation in the received signal strength with a threshold value.

In the determining of whether the terminal is in the on-board state with respect to the first base station by comparing the variation in the received signal strength with the threshold value, the at least one processor may cause the terminal to perform: determining whether the variation in the received signal strength exceeds the threshold value, wherein the terminal may be determined to be in the on-board state with respect to the first base station when the variation in the received signal strength does not exceed the threshold value, and the terminal may be determined to be not in the on-board state with respect to the first base station when the variation in the received signal strength exceeds the threshold value.

In the determining of whether the terminal is in the on-board state with respect to the first base station, the at least one processor may cause the terminal to perform: in response to determining that the terminal is in the on-board state with respect to the first base station according to a result of the primary determination, performing a secondary determination on whether mobile integrated access and backhaul (IAB) indication information exists in the system information; and in response to determining that the mobile IAB indication information exists in the system information, determining that the terminal is in the on-board state with respect to the first base station as a result of the secondary determination.

According to the present disclosure, a terminal can receive a signal from a cell and measure a variation in the received signal strength. Additionally, according to the present disclosure, the terminal can determine that it is onboard with the corresponding cell if the variation in the received signal strength does not exceed a certain threshold. Furthermore, according to the present disclosure, the terminal can perform reselection for the on-boarded cell.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a second exemplary embodiment of a communication system.

FIG. 4 is a conceptual diagram illustrating a first exemplary embodiment of received strengths of signals received at an on-board terminal from a moving cell and a terrestrial cell according to movement of a moving base station.

FIG. 5 is a conceptual diagram illustrating a first exemplary embodiment of a method for identifying whether a terminal is an on-board terminal.

FIG. 6 is a flowchart illustrating a first exemplary embodiment of a method for identifying whether a terminal is an on-board terminal.

FIG. 7 is a flowchart illustrating a first exemplary embodiment of a mobility management method in a communication system.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

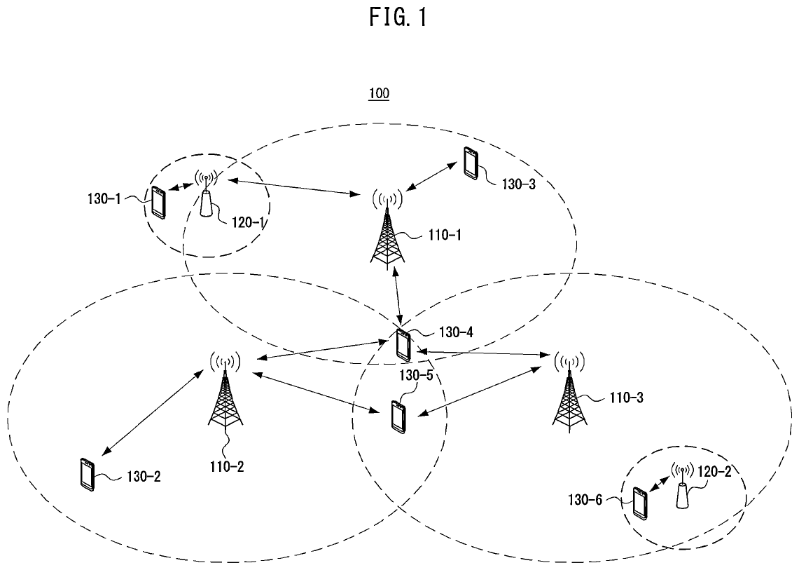

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

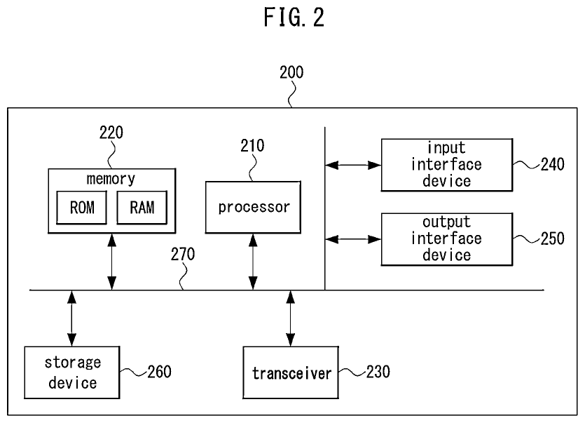

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

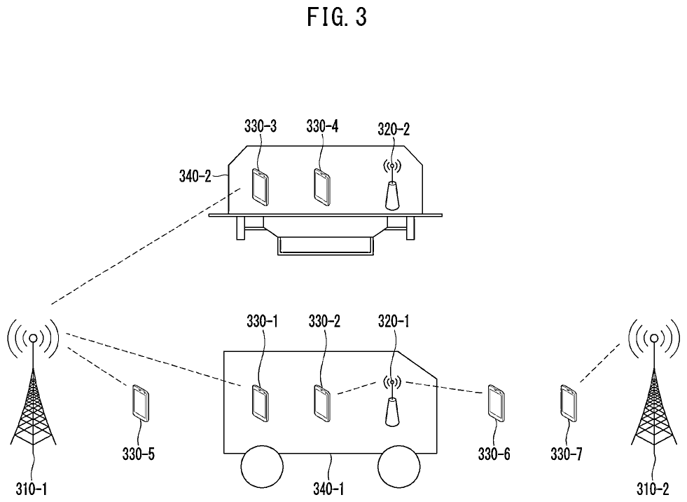

FIG. 3 is a conceptual diagram illustrating a second exemplary embodiment of a communication system.

Referring to FIG. 3, a communication system 300 may include terrestrial base stations 310-1 and 310-2, moving base stations 320-1 and 320-2, and terminals 330-1 to 330-7. The terrestrial base stations 310-1 and 310-2 may be fixed base stations. The moving base stations 320-1 and 320-2 may be mounted on land/sea vehicles such as buses/trains/ships or aerial vehicles such as urban air mobility (UAM). For example, the first moving base station 320-1 may be mounted on a land vehicle 340-1 such as bus, and the second moving base station 320-2 may be mounted on an aerial vehicle 340-2 such as UAM. Here, the UAM may be a future air traffic system operated for the purpose of transporting passengers, cargo, etc. at an altitude of 300 m to 1,000 m using a vertical take-off and landing (VTOL) aircraft. The moving base stations 320-1 and 320-2 may form moving cells.

The terminals 330-1 and 330-2 among the terminals 330-1 to 330-7 may be located in the land vehicle 340-1. These terminals 330-1 and 330-2 may be referred to as on-board terminals. In addition, the terminals 330-3 and 330-4 among the terminals 330-1 to 330-7 may be mounted on the aerial vehicle 340-2. These terminals 330-3 and 330-4 may be referred to as on-board terminals. In addition, some terminals 330-5 to 330-7 among the terminals 330-1 to 330-7 may be located around the vehicles 340-1 and 340-2. These terminals 330-5 to 330-7 may be referred to as neighboring terminals.

Meanwhile, the moving base station may be configured as a 3GPP mobile integrated access and backhaul (IAB) node. The moving base station may form a moving cell coverage to provide mobile communication services to terminals of passengers boarding the vehicle. The cell coverage of the moving base station may overlap with a cell coverage of the fixed base station. The cell coverage of the moving base station may move together with movement of the vehicle.

In the environment where the cell coverage of fixed base stations and moving base stations overlap, the on-board terminal may be connected to the terrestrial base station or the moving base station, and the neighboring terminals may also be connected to the terrestrial base station or the moving base station. In this case, it may be preferable for the on-board terminal to be connected to the moving base station mounted on the vehicle on which the passenger carrying the on-board terminal is aboard. In the 3GPP mobile IAB system, the terminal and/or network may need to identify that the terminal is in an on-board state for the following reasons.
When the terminal is identified as being on-board, cell selection and reselection may be performed on the moving cell. An on-board terminal in the idle mode and inactive mode may camp on the cell of the terrestrial base station. In this case, the on-board terminal may repeat cell reselection according to the movement of the moving base station. To prevent such frequent cell reselection, the on-board terminal may identify whether itself is the on-board terminal. The on-board terminal may perform cell selection and reselection on the moving cell by identifying itself as the on-board terminal.
When the network identifies the terminal as an on-board terminal, the network may allow the on-board terminal to perform a random access channel (RACH)-less handover. In the 3GPP IAB technology, the on-board terminal may maintain uplink (UL) synchronization and thus perform a RACH-less handover. If the terminal reports the on-board state of the terminal to the moving base station, the moving base station may configure the RACH-less handover.
A terminal in the radio resource control (RRC) connected state may be connected to a fixed base station. The terminal in the RRC connected state may experience frequent inter-cell handovers as the moving base station moves. If the terminal identifies itself as an on-board terminal, frequent handovers can be prevented by attempting to perform a handover to the moving base station mounted on the vehicle.

The terminal may be in idle or inactive mode. When the terminal is in idle mode, the wireless connection with the base station may be released. The terminal may camp on a normal cell in either idle or inactive mode and receive downlink traffic via paging. Additionally, when user traffic occurs, the terminal may establish a wireless connection with the camped-on cell to transmit uplink data. As the terminal moves in idle or inactive mode, it may change the camped cell through cell reselection.

In the 3GPP, the cell reselection procedure of the terminal may be performed using received strengths of reference signals of a cell to be camped on and neighboring cells (e.g. reference signals received power (RSRP), reference signal received quality (RSRQ), etc.), and parameters such as cell reselection priority, Q-offset, Q-hysteresis, reselection threshold, reselection timer, etc. broadcasted through system information block(s) (SIB(s)). For example, cell reselection priority parameters may indicate a priority for reselecting an inter-frequency cell or an inter-radio access technology (RAT) cell. Information on such cell reselection priority parameters may be broadcasted through system information (SI).

When a neighboring cell is an inter-frequency or inter-RAT cell, and a reselection priority of the neighboring cell is higher than a reselection priority of the cell on which the terminal is camped, the terminal may reselect the neighboring cell if Condition 1 below is satisfied.
Condition 1) A case where a received signal strength of the neighboring cell (e.g. ‘S_rxlev’) is maintained higher than a threshold value broadcasted through SI (e.g. ‘Thresh_X’ or ‘HighP’) until expiration of a reselection timer (e.g. ‘T_reselection_RAT’).

When a neighboring cell is an inter-frequency or inter-RAT cell, and a reselection priority of the neighboring cell is lower than a reselection priority of the cell on which the terminal is camped, the terminal may reselect the neighboring cell if both of Conditions 2 and 3 below are satisfied.
Condition 2) A case where a received signal strength of the camped-on cell is lower than a threshold value broadcasted through SI (e.g. ‘Thresh_Serving’ or ‘LowP’).
Condition 3) A case where a received signal strength of the neighboring cell is maintained higher than the threshold value broadcasted through SI (e.g. ‘Thresh_X’ or ‘LowP’) until expiration of the reselection timer.

When a neighboring cell is an intra-frequency cell or is an inter-frequency or inter-RAT cell with the same cell reselection priority, the cell reselection procedure may be performed through cell ranking. In the cell ranking, the terminal may calculate a received strength of the camped-on cell as in Equation 1, and may calculate received strengths of neighboring cells as in Equation 2.

$${R}_{s} = {Q}_{meas \_ s -} + {Q}_{hyst} - {Qoffset}_{temp} \qquad [ Equation l ]$$

$${R}_{n} = {Q}_{meas \_ n} - {Q}_{offset} - {Qoffset}_{temp} \qquad [ Equation 2 ]$$

In Equations 1 and 2, Q_{meas_s} and Q_{meas_n} may be RSRP measurement values. In Equation 1, Q_{hyst} may be a Q-hyst value broadcasted through an SIB of the camped-on cell. In Equation 2, Q_{offset} may be a Q-OffsetCell value broadcasted through a SIB in case of inter-frequency cell. In contrast, in Equation 2, Q_{offset} may be 0 if the Q-offsetCell value is not broadcasted through the SIB in case of inter-frequency cell. In Equation 2, Q_{offset} may be a sum of the Q-OffsetCell value and a Q-OffsetFreq value of the SIB if the Q-OffsetCell value is broadcasted through the SIB in case of inter-frequency cell. In contrast, in Equation 2, Q_{offset} may use the Q-OffsetFreq value if the Q-OffsetCell value is not broadcasted through the SIB in case of inter-frequency cell. Here, the Q-OffsetFreq value may be broadcasted via the SIB. In Equations 1 and 2, Qoffsetₜₑₘₚ may be a temporary Q-Offset value applied when an RRC connection establishment attempt fails. The terminal may calculate Rₙ of neighboring cells according to Equation 2 and rank them from the largest. If Rₙ of a neighboring cell is maintained higher than Rₛ of the camped-on cell during a cell reselection time T_{reselection}, the terminal may reselect the neighboring cell.

It may be preferable for an on-board terminal of a passenger on a vehicle to camp on a moving cell of a moving base station installed on the vehicle. If the on-board terminal is camped on a terrestrial cell, frequent cell reselection may occur depending on movement of the moving cell. Accordingly, the present disclosure proposes methods for a terminal to identify an on-board state by itself and methods for the on-board terminal to select/reselect a cell of a moving base station on which it is aboard. The present disclosure proposes methods for an on-board terminal connected to a moving base station mounted on a vehicle to identify itself as being in an on-board state. In addition, the present disclosure proposes cell reselection methods in idle mode and inactive mode when the terminal is in the on-board state.

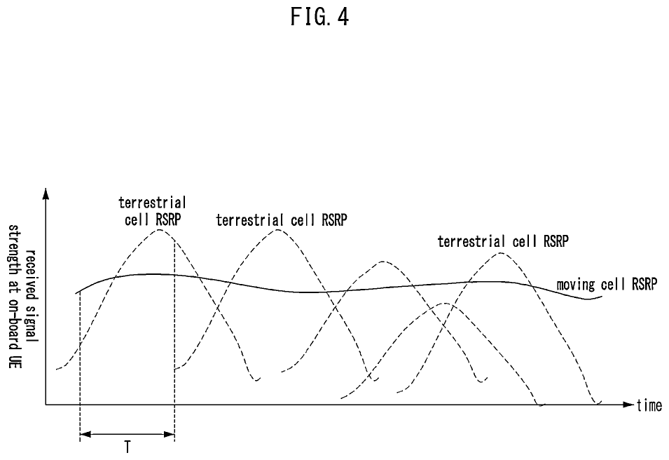

FIG. 4 is a conceptual diagram illustrating a first exemplary embodiment of received strengths of signals received at an on-board terminal from a moving cell and a terrestrial cell according to movement of a moving base station.

Referring to FIG. 4, a terrestrial cell RSRP may refer to a received signal strength of a terrestrial cell at the terminal, and a moving cell RSRP may refer to a received signal strength of a moving cell at the terminal. A moving base station mounted on a vehicle such as a bus/train/ship may repeat moving and stopping. A moving base station mounted on a vehicle such as UAM may be affected by a cell coverage of a terrestrial base station.

The moving base station may pass through cell coverages of surrounding base stations while moving. As the moving base station moves, a received signal strength of a cell of the terrestrial base station at the on-board terminal may change significantly for a certain period of time T. On the other hand, the received signal strength of the cell of the moving base station at the on-board terminal for the certain period of time T may be maintained at a constant level regardless of the passage of time. Here, T may be a positive real number.

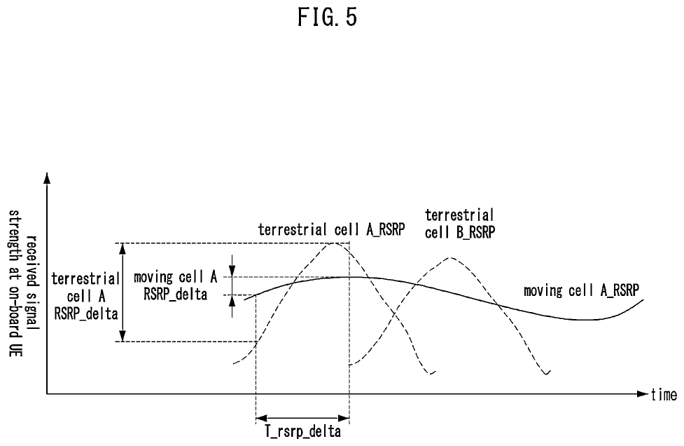

FIG. 5 is a conceptual diagram illustrating a first exemplary embodiment of a method for identifying whether a terminal is an on-board terminal.

Referring to FIG. 5, a terrestrial cell RSRP may refer to a received signal strength of a terrestrial cell at the terminal, and a moving cell RSRP may refer to a received signal strength of a moving cell at the terminal. For example, the received signal strength may indicate an RSRP, but may include an RSRQ or RSSI. RSRPs of terrestrial cells A and B may vary significantly over time. However, the RSRP of a moving cell A may be constant.

T_rsrp_delta may be an on-board evaluation period for determining received signal strength variations of the moving cell and the fixed cell. Alternatively, the on-board evaluation period may be an on-board evaluation time. A terrestrial cell RSRP_delta may be the amount of change in the received signal strength of the signal received from the terrestrial cell during the on-board evaluation period. A moving cell RSRP_delta may be the amount of change in the received signal strength of the signal received from the moving cell during the on-board evaluation period.

The terminal may calculate the received signal strength variation of each cell during the on-board evaluation period. Then, the terminal may compare the calculated received signal strength variation of each cell with an on-board decision threshold. Here, the on-board decision threshold may be expressed as Thresh_on_board. As a result of comparing the received signal strength variation of the moving cell A with the on-board decision threshold, the terminal may determine that the received signal strength variation of the moving cell A is less than or equal to the on-board decision threshold. Accordingly, the terminal may determine that the terminal is in an on-board state with respect to the moving cell A. On the other hand, as a result of comparing the received signal strength variation of the terrestrial cell A with the on-board decision threshold, the terminal may determine that the received signal strength variation of the terrestrial cell A is greater than the on-board decision threshold. Accordingly, the terminal may determine that the terminal is not in an on-board state with respect to the terrestrial cell A.

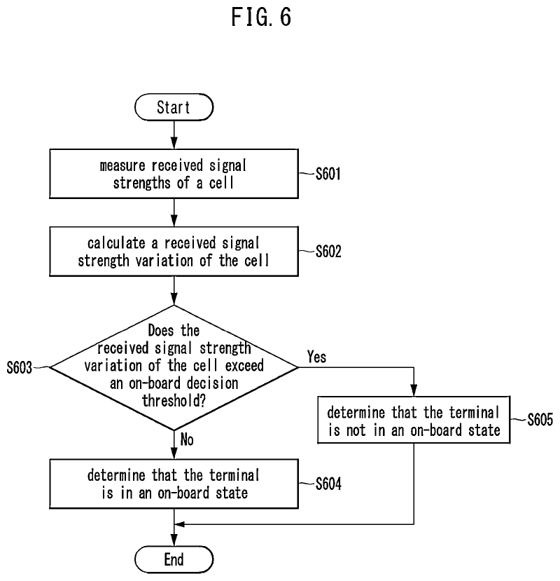

FIG. 6 is a flowchart illustrating a first exemplary embodiment of a method for identifying whether a terminal is an on-board terminal.

Referring to FIG. 6, a camped-on cell, which is an IAB node, may transmit a signal to the terminal. In addition, a neighboring cell may transmit a signal to the terminal. Then, the terminal may receive the signal from the camped-on cell and measure a received signal strength of the received signal. In addition, the terminal may receive the signal from the neighboring cell and measure a received signal strength of the received signal (S601). The terminal may calculate a received signal strength variation, which is the amount of change in the received signal strength of the signal received from the camped-on cell during the on-board evaluation period. In addition, the terminal may calculate a received signal strength variation, which is the amount of change in the received signal strength of the signal received from the neighboring cell during the on-board evaluation period (S602).

The terminal may determine whether the calculated received signal strength variation of the camped-on cell, which is the IAB node, exceeds the on-board decision threshold (S603). As a result of the determination, if the received signal strength variation of the camped-on cell does not exceed (or is less than) the on-board decision threshold, the terminal may determine that the terminal is in an on-board state with respect to the camped-on cell (S604). On the other hand, if the received signal strength variation of the camped-on cell exceeds the on-board decision threshold, the terminal may determine that the terminal is not in an on-board state with respect to the camped-on cell (S605).

Referring again to FIG. 3, a procedure for determining an on-board state of the terminal camping on a moving cell will be described. The moving cell 320-1 and the terrestrial cells 310-1 and 310-2 may transmit signals to the terminals 330-1 to 330-6. The terminal 330-2 may be in a state of being camped on the moving cell 320-1. The terminal 330-2 may receive the signal from the camped-on cell 320-1 and measure a received signal strength of the received signal. The terminal 330-2 may determine whether a received signal strength variation of the camped-on cell 320-1 exceeds the on-board decision threshold. As a result of the determination, if the received signal strength variation of the camped-on cell 320-1 does not exceed the on-board decision threshold, the terminal may determine that the terminal is in an on-board state with respect to the camped-on cell 320-1. In addition, the terminal 330-6 may receive the signal from the camped-on cell 320-1, measure a received signal strength of the received signal, and determine whether a received signal strength variation exceeds the on-board decision threshold. The terminal 330-6 may determine that it is not in an on-board state with respect to the camped-on cell 320-1 if the received signal strength variation of the camped-on cell 320-1 exceeds the on-board decision threshold as a result of the determination.

Continuing with reference to FIG. 3, a procedure for determining an on-board state of a terminal camping on a terrestrial cell will be described. The moving cell 320-1 and the terrestrial cells 310-1 and 310-2 may transmit signals to the terminals 330-1 to 330-6. The terminal 330-1 may be in a state of being camped on the terrestrial cell 310-1. The terminal 330-1 may receive signals from the camped-on cell 310-1 and the neighboring moving cell 320-1, and may measure received signal strengths of the received signals. The terminal 330-1 may determine whether a received signal strength variation of the camped-on terrestrial cell 310-1 exceeds the on-board decision threshold. If the terminal determines that the received signal strength variation of the camped-on terrestrial cell 310-1 exceeds the on-board decision threshold, the terminal may determine that the terminal is not in an on-board state with respect to the camped-on terrestrial cell 310-1. In addition, the terminal 330-1 may receive the signal from the neighboring moving cell 320-1 and measure a received signal strength of the received signal. The terminal 330-1 may determine whether a received signal strength variation of the neighboring moving cell 320-1 exceeds the on-board decision threshold. If the terminal determines that the received signal strength variation of the neighboring moving cell 320-1 does not exceed the on-board decision threshold, the terminal 330-1 may determine that the terminal is in an on-board state with respect to the neighboring moving cell 320-1.

Meanwhile, if the camped-on cell is a mobile IAB node, the camped-on cell may broadcast mobile IAB indication information through an SIB. Accordingly, the terminal may obtain the mobile IAB indication information from the camped-on cell, and may identify that the camped-on cell is a mobile IAB node through the mobile IAB indication information of the SIB obtained from the camped-on cell. On the other hand, if the camped-on cell is not a mobile IAB node, the terminal may not obtain the mobile IAB indication information through the SIB. In this case, the terminal may not determine whether the terminal is an on-board terminal because the camped-on cell is not a moving cell (or moving base station).

Referring to FIG. 6 again, the terminal may determine whether the calculated received signal strength variation of the neighboring cell exceeds the on-board decision threshold (S603). If the received signal strength variation of the neighboring cell does not exceed the on-board decision threshold, the terminal may determine that the terminal is in an on-board state with respect to the neighboring cell (S604). On the other hand, if the received signal strength variation of the neighboring cell exceeds the on-board decision threshold, the terminal may determine that the terminal is not in an on-board state with respect to the neighboring cell (S605).

Meanwhile, if the neighboring cell is a mobile IAB node, the neighboring cell may broadcast mobile IAB indication information through an SIB. Accordingly, the terminal may obtain the mobile IAB indication information from the neighboring cell, and may identify that the neighboring cell is a mobile IAB node through the mobile IAB indication information of the SIB obtained from the neighboring cell. On the other hand, if the neighboring cell is not a mobile IAB node, the terminal may not obtain the mobile IAB indication information through the SIB. In this case, the terminal may not determine whether the terminal is an on-board terminal because the neighboring cell is not a moving cell (or moving base station).

The terminal in the on-board state may determine the on-board state every on-board evaluation period (T_rsrp_delta). The terminal in the on-board state may measure received signal strengths of the camped-on cell and the neighboring cell. During the on-board evaluation period (T_rsrp_delta), the terminal may calculate a received signal strength variation (RSRP_delta) of each cell, and determine whether the received signal strength variation (RSRP_delta) of each cell is within a range of the on-board decision threshold (Thresh_on_board). If the received signal strength variation (RSRP_delta) is greater than the on-board decision threshold (Thresh_on_board), the terminal may determine that the terminal is not in the on-board state. In the present disclosure, information including the on-board evaluation period (T_rsrp_delta) and the on-board decision threshold (Thresh_on_board) may be broadcasted through a cell SIB. In this case, the terminal may determine whether the camped-on cell is a mobile IAB node.

Hereinafter, a mobility control method of an on-board terminal in idle mode or inactive mode proposed by the present disclosure will be described. According to exemplary embodiments of the present disclosure, on-board cell reselection parameters may be additionally defined. The on-board cell reselection parameters may be different from terrestrial cell reselection parameters defined in the existing 3GPP technical specifications. The on-board cell reselection parameters may be added to an SIB and broadcasted. The on-board cell reselection parameters may include the following parameters.
cell reselection priority
Q-hysteresis
Q-offset, Q-OffsetCell, Q-OffsetFrequency
reselection threshold
reselection timer

The on-board cell reselection parameters may include some parameters of the terrestrial cell reselection parameters. Alternatively, the on-board cell reselection parameters may be configured as offset values for the terrestrial cell reselection parameters. The on-board cell reselection parameters may be configured as values set so that the terminal in the on-board state can easily reselect a moving cell.

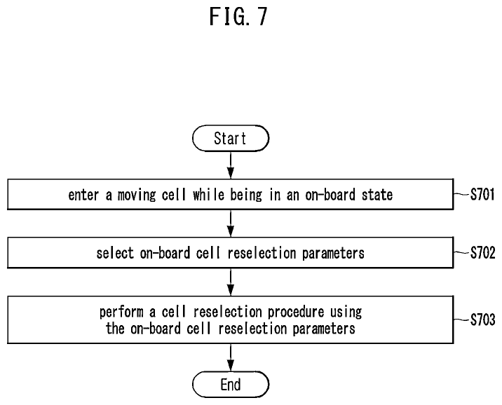

FIG. 7 is a flowchart illustrating a first exemplary embodiment of a mobility management method in a communication system.

Referring to FIG. 7, if a terminal is in an on-board state with respect to a moving cell (S701), the terminal may select the on-board cell reselection parameters (S702). Then, the terminal may perform a cell reselection procedure using the selected on-board cell reselection parameters (S703). On the other hand, if the terminal is not in an on-board state, the terminal may perform a cell reselection procedure by selecting the terrestrial cell reselection parameters. In an exemplary embodiment of the present disclosure, a cell reselection priority for an on-board cell may be assigned to be higher than a cell reselection priority of other terrestrial cells. This may allow the terminal to more easily reselect a moving cell during the cell reselection procedure.

In the present disclosure, the cell reselection priority parameter among the on-board cell reselection parameters may be controlled so that the terminal in the on-board state can preferentially select a moving cell.

Referring again to FIG. 3, it may be assumed that the terminal 330-1 is an on-board terminal boarding the moving cell 320-1 and is camped on the terrestrial cell 310-1. The terminal 330-1 may measure received signal strengths of the camped-on terrestrial cell 310-1 and the moving cell 320-1, and may determine whether a received signal strength variation of each cell exceeds the on-board decision threshold. The terminal 330-1 may determine that the terminal is in the on-board state with respect to the neighboring moving cell 320-1 as a result of the determination, and the terminal 330-1 may perform a cell reselection procedure by applying a cell reselection priority for on-board cells to make a cell reselection priority of the neighboring moving cell 320-1 be higher than a cell reselection priority of the camped-on terrestrial cell 310-1. In this case, the cell reselection priority for on-board cells may be set higher than the cell reselection priority for the terrestrial cells. In this manner, the terminal may increase a possibility of selecting the moving cell 320-1 over the terrestrial cell 310-1.

In addition, in the present disclosure, the Q-offset parameter among the on-board cell reselection parameters may be controlled to allow the terminal in the on-board state to preferentially select a moving cell. It may be assumed that the terminal 330-1 is an on-board terminal boarding the moving cell 320-1, and is in a state of being camped on the terrestrial cell 310-1. The terminal 330-1 may measure received signal strengths of the camped-on terrestrial cell 310-1 and the moving cell 320-1, and may determine whether a received signal strength variation of each cell exceeds the on-board decision threshold. As a result of the determination, the terminal 330-1 may determine that itself is in the on-board state with respect to the neighboring moving cell 320-1. The terminal 330-1 may calculate the received strength Rₛ of the camped-on cell 310-1 by applying the Q-hysteresis for terrestrial cells according to Equation 1. In addition, the terminal 330-1 may calculate the received strength Rₙ of the neighboring moving cell 320-1 by applying the Q-offset for on-board cells according to Equation 2. The Q-offset for on-board cells may be set to a low value so that the terminal 330-1 selects the moving cell 320-1 and cell reselection to the moving cell can easily occur. The terminal 330-1 may compare the received strength Rₛ of the camped-on terrestrial cell 310-1 with the received strength Rₙ of the neighboring moving cell 320-1. As a result of the comparison, the terminal 330-1 may maintain a state in which the received strength Rₙ of the neighboring moving cell 320-1 is greater than the received strength Rₛ of the camped-on terrestrial cell 310-1 during the cell reselection time. Accordingly, the terminal 330-1 may change the camp-on cell by selecting the neighboring moving cell 320-1.

In addition, in the present disclosure, the Q-hysteresis parameter among the on-board cell reselection parameters may be controlled so that the terminal in the on-board state continues to select the moving cells. It may be assumed that the terminal 330-2 is an on-board terminal boarding the moving cell 320-1 and is in a state of being camped on the moving cell 320-1. The terminal 330-2 may measure received signal strengths of the camped-on moving cell 320-1 and the terrestrial cells 310-1 and 310-2, and may determine whether a received signal strength variation of each cell exceeds the on-board decision threshold. As a result of the determination, the terminal 330-2 may determine that the terminal is in the on-board state with respect to the camped-on moving cell 320-1. The terminal 330-2 may calculate the received strength Rₛ of the camped-on cell 320-1 by applying the Q-hysteresis for on-board cells according to Equation 1. The terminal 330-2 may calculate the received strength Rₙ of the neighboring cells 310-1 and 310-2 by applying the Q-offset for terrestrial cells according to Equation 2. The Q-hysteresis for on-board cells may be set to a high value so that the terminal 330-2 can easily select the moving cell 320-1 and cell reselection to the neighboring terrestrial cell does not occur. The terminal 330-2 may compare the received strength Rₛ of the camped-on moving cell 320-1 with the received strength Rₙ of the neighboring terrestrial cells 310-1 and 310-2. As a result of the comparison, the terminal 330-2 may maintain a state in which the received strength Rₛ of the camped-on moving cell 320-1 is greater than the received strength Rₙ of the neighboring terrestrial cells 310-1 and 310-2 during the cell reselection time. Accordingly, the terminal 330-2 may select the camped-on moving cell 320-1 and not perform cell reselection to the neighboring cell.

The above-described exemplary embodiment may be as an exemplary embodiment of applying the cell reselection priority among the existing terrestrial cell reselection parameters broadcasted through SIBs as the on-board cell reselection parameters. However, one or more terrestrial cell reselection parameters may be defined and used as the on-board reselection parameters. As another example, an on-board reselection timer may be used. The on-board reselection timer broadcasted through an SIB may be assigned a longer time than the terrestrial cell reselection timer. As a result, the on-board terminal may be allowed to stay in the moving cell for a longer time.

The present disclosure provides methods for a terminal to identify itself as an on-board terminal boarding a moving cell. In addition, the present disclosure provides methods for managing mobility of a terminal according to movement of a moving base station. In addition, according to the present disclosure, an on-board terminal may not need to perform frequent cell reselection.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving system information including terrestrial cell reselection parameters and on-board cell reselection parameters;
determining whether the terminal is in an on-board state with respect to a first base station; and
in response to determining that the terminal is in the on-board state with respect to the first base station, performing cell reselection by applying the on-board cell reselection parameters for cell reselection evaluation on the first base station.

2. The method according to claim 1, further comprising: before determining whether the terminal is in the on-board state with respect to the first base station, camping on the first base station, wherein the first base station is a moving base station.

3. The method according to claim 1, further comprising: before determining whether the terminal is in the on-board state with respect to the first base station, camping on a second base station, wherein the first base station is a moving base station and the second base station is a terrestrial base station.

4. The method according to claim 1, further comprising: in response to determining that the terminal is not in the on-board state with respect to the first base station, performing cell reselection by applying the terrestrial cell reselection parameters for cell reselection evaluation on the first base station.

5. The method according to claim 1, wherein the determining of whether the terminal is in the on-board state with respect to the first base station comprises:
receiving a signal from the first base station;
measuring a received signal strength of the signal received from the first base station; and
performing primary determination on whether the terminal is in the on-board state with respect to the first base station based on a variation in the measured received signal strength.

6. The method according to claim 5, wherein the performing of the primary determination on whether the terminal is in the on-board state with respect to the first base station comprises:
calculating the variation in the measured received signal strength during an on-board evaluation period; and
determining whether the terminal is in the on-board state with respect to the first base station by comparing the variation in the received signal strength with a threshold value.

7. The method according to claim 6, wherein the determining of whether the terminal is in the on-board state with respect to the first base station by comparing the variation in the received signal strength with the threshold value comprises: determining whether the variation in the received signal strength exceeds the threshold value,
wherein the terminal is determined to be in the on-board state with respect to the first base station when the variation in the received signal strength does not exceed the threshold value, and the terminal is determined to be not in the on-board state with respect to the first base station when the variation in the received signal strength exceeds the threshold value.

8. The method according to claim 6, wherein the determining of whether the terminal is in the on-board state with respect to the first base station comprises:
in response to determining that the terminal is in the on-board state with respect to the first base station according to a result of the primary determination, performing a secondary determination on whether mobile integrated access and backhaul (IAB) indication information exists in the system information; and
in response to determining that the mobile IAB indication information exists in the system information, determining that the terminal is in the on-board state with respect to the first base station as a result of the secondary determination.

9. The method according to claim 1, wherein a cell reselection priority of the on-board cell reselection parameters is higher than a cell reselection priority of the terrestrial cell reselection parameters.

10. The method according to claim 1, wherein a Q-offset of the on-board cell reselection parameters is smaller than a Q-offset of the terrestrial cell reselection parameters.

11. The method according to claim 1, wherein a Q-hysteresis of the on-board cell reselection parameters is bigger than a Q-hysteresis of the terrestrial cell reselection parameters.

12. A terminal comprising at least one processor, wherein the at least one processor causes the terminal to perform:
receiving system information including terrestrial cell reselection parameters and on-board cell reselection parameters;
determining whether the terminal is in an on-board state with respect to a first base station; and
in response to determining that the terminal is in the on-board state with respect to the first base station, performing cell reselection by applying the on-board cell reselection parameters for cell reselection evaluation on the first base station.

13. The terminal according to claim 12, wherein the at least one processor causes the terminal to perform: before determining whether the terminal is in the on-board state with respect to the first base station, camping on the first base station, wherein the first base station is a moving base station.

14. The terminal according to claim 12, wherein the at least one processor causes the terminal to perform: before determining whether the terminal is in the on-board state with respect to the first base station, camping on a second base station, wherein the first base station is a moving base station and the second base station is a terrestrial base station.

15. The terminal according to claim 12, wherein the at least one processor causes the terminal to perform: in response to determining that the terminal is not in the on-board state with respect to the first base station, performing cell reselection by applying the terrestrial cell reselection parameters for cell reselection evaluation on the first base station.

16. The terminal according to claim 12, wherein in the determining of whether the terminal is in the on-board state with respect to the first base station, the at least one processor causes the terminal to perform:
receiving a signal from the first base station;
measuring a received signal strength of the signal received from the first base station; and
performing primary determination on whether the terminal is in the on-board state with respect to the first base station based on a variation in the measured received signal strength.

17. The terminal according to claim 16, wherein in the performing of the primary determination on whether the terminal is in the on-board state with respect to the first base station, the at least one processor causes the terminal to perform:
calculating the variation in the measured received signal strength during an on-board evaluation period; and
determining whether the terminal is in the on-board state with respect to the first base station by comparing the variation in the received signal strength with a threshold value.

18. The terminal according to claim 17, wherein in the determining of whether the terminal is in the on-board state with respect to the first base station by comparing the variation in the received signal strength with the threshold value, the at least one processor causes the terminal to perform: determining whether the variation in the received signal strength exceeds the threshold value, wherein the terminal is determined to be in the on-board state with respect to the first base station when the variation in the received signal strength does not exceed the threshold value, and the terminal is determined to be not in the on-board state with respect to the first base station when the variation in the received signal strength exceeds the threshold value.

19. The terminal according to claim 17, wherein in the determining of whether the terminal is in the on-board state with respect to the first base station, the at least one processor causes the terminal to perform:
in response to determining that the terminal is in the on-board state with respect to the first base station according to a result of the primary determination, performing a secondary determination on whether mobile integrated access and backhaul (IAB) indication information exists in the system information; and
in response to determining that the mobile IAB indication information exists in the system information, determining that the terminal is in the on-board state with respect to the first base station as a result of the secondary determination.
